(19) United States
(12) Patent Application Publication
(10) Pub. No.: US 2025/0031210 A1
(43) Pub. Date: Jan. 23, 2025

(54) ENHANCEMENTS ON UPLINK TRANSMISSION

(71) Applicant: Nokia Technologies Oy, Espoo (FI)

(72) Inventors: Jingyuan SUN, Beijing (CN); Mads LAURIDSEN, Aalborg (DK); Frank FREDERIKSEN, Aalborg (DK); Ping YUAN, Beijing (CN)

(21) Appl. No.: 18/713,639

(22) PCT Filed: Dec. 8, 2021
(86) PCT No.: PCT/CN2021/136343

§ 371 Date: May 25, 2024

(51) Int. Cl. H04W 72/21; H04L 5/00

(52) U.S. Cl. CPC H04W 72/21; H04L 5/0005

(57) ABSTRACT

Embodiments of the present disclosure relate to methods, devices, apparatuses, and computer readable medium of enhancements on uplink transmission. The method comprises: transmitting, to a second device, a first group of transmission repetitions based on first uplink synchronization information: prior to transmitting a second group of transmission repetitions, determining second uplink synchronization information based on system broadcast information for deriving transmission compensation in at least one of time domain and frequency domain; and transmitting, to the second device and based on the second uplink synchronization information, the second group of transmission repetitions. The method helps guarantee the effective receipt of uplink repetitions with compensation jump in time or frequency domain or update due to changing of uplink synchronization information. In addition, the network knows how to combine or select repetitions for best performance when the UE automatically adjusts the UL compensation in time or frequency domain during the repetitions.

### FIELD

Embodiments of the present disclosure generally relate to the field of telecommunication and in particular, to devices, methods, apparatus and computer readable storage media of enhancements on uplink (UL) transmission.

### BACKGROUND

In Narrow band Internet of Things (NB-IoT), repetitions of UL transmission are used for improving the quality of packet transmissions considering low cost (e.g., a reduced number of antennas), low complexity UE and possibly a large path loss. This is especially beneficial when IoT UE is indoor or with sheltering. In an LTE system, for each physical packet, the NB-IoT transmission time may be determined as (the repetition number*the number of resource unit (RU)*the number of slot in the RU*length of slot). Given the largest repetition number, the number of the RU, and the number of slot in the RU defined in LTE, the maximum transmission time could be 0.5 ms*128*10*16=10240 ms for 15 kHz subcarrier spacing (SCS), or 2 ms*128*10*16=40960 ms for 3.75 kHz SCS. On the other hand, the network combines the repetitions to obtain a receiving gain against the large pathloss between the network and the IoT UE.

With the arrival of 5G (NR), the NB-IoT/eMTC (Enhanced Machine Type Communication) is supported for Non-Terrestrial Network (NTN). In the NTN scenario, the radio coverage is provided by a satellite which may have a speed relative to Earth. As one of the widely used satellites in NTN scenarios, a relative speed of the Low Earth Orbit (LEO) satellite may be about 7.56 km/second. When considering a change of distance between the satellite and the UE on the ground, it is necessary to control and update frequency and time synchronization as the satellite moves time and frequency synchronization needs to be adjusted along with the satellite's movement.

### SUMMARY

In general, example embodiments of the present disclosure provide a solution for UL transmission.

In a first aspect, there is provided a first device. The first device comprises: at least one processor; and at least one memory including computer program codes. The at least one memory and the computer program codes are configured to, with the at least one processor, cause the first device to: transmit, to a second device and based on first uplink synchronization, information a first group of transmission repetitions; prior to transmitting a second group of transmission repetitions, determine second uplink synchronization information based on system broadcast information for deriving transmission compensation in at least one of time domain and frequency domain; and transmit, to the second device and based on the second uplink synchronization information, the second group of transmission repetitions.

In a second aspect, there is provided a second device. The second device comprises: at least one processor; and at least one memory including computer program codes. The at least one memory and the computer program codes are configured to, with the at least one processor, cause the second device to: receive, from a first device, a first group of transmission repetitions associated with first uplink synchronization information; and receive, from the first device, a second group of transmission repetitions associated with second uplink synchronization information.

In a third aspect, there is provided a method. The method comprises: transmitting, at a first device and to a second device, a first group of transmission repetitions based on first uplink synchronization information; prior to transmitting a second group of transmission repetitions, determining second uplink synchronization information based on system broadcast information for deriving transmission compensation in at least one of time domain and frequency domain; and transmitting, to the second device and based on the second uplink synchronization information, the second group of transmission repetitions.

In a fourth aspect, there is provided a method. The method comprises: receiving, at a second device and from a first device, a first group of transmission repetitions associated with first uplink synchronization information; and receiving, from the first device, a second group of transmission repetitions associated with second uplink synchronization information.

In a fifth aspect, there is provided a first apparatus. The first apparatus comprises: means for transmitting, to a second apparatus, a first group of transmission repetitions based on first uplink synchronization information; means for prior to transmitting a second group of transmission repetitions, determining second uplink synchronization information based on system broadcast information for deriving transmission compensation in at least one of time domain and frequency domain; and means for transmitting, to the second apparatus and based on the second uplink synchronization information, the second group of transmission repetitions.

In a sixth aspect, there is provided a second apparatus. The second apparatus comprises: means for receiving, from a first apparatus, a first group of transmission repetitions associated with first uplink synchronization information; and means for receiving, from the first apparatus, a second group of transmission repetitions associated with second uplink synchronization information.

In a seventh aspect, there is provided a non-transitory computer readable medium. The non-transitory computer readable medium comprises program instructions for causing an apparatus to perform the method according to the third aspect.

In an eighth aspect, there is provided a non-transitory computer readable medium. The non-transitory computer readable medium comprises program instructions for causing an apparatus to perform the method according to the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which embodiments of the present disclosure can be implemented;

FIG. 2 shows a signaling chart illustrating an example UL transmission procedure according to some example embodiments of the present disclosure;

FIG. 3 shows a schematic diagram illustrating an example of UL transmission repetitions with a UE assistance signal according to some example embodiments of the present disclosure;

FIGS. 4A-4B show a schematic diagram illustrating another example of UL transmission repetitions according to some example embodiments of the present disclosure;

FIG. 5 shows a schematic diagram illustrating still another example of UL transmission repetitions according to some example embodiments of the present disclosure;

FIG. 6 illustrates a flowchart of an example method implemented at a first device according to example embodiments of the present disclosure;

FIG. 7 illustrates a flowchart of an example method implemented at a second device according to example embodiments of the present disclosure;

FIG. 8 illustrates a simplified block diagram of an apparatus that is suitable for implementing example embodiments of the present disclosure; and

FIG. 9 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Non-terrestrial network (NTN), Narrow Band Internet of Things (NB-IoT), IoT over NTN (Internet of Things over Non-terrestrial network) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In NR NTN scenarios, it is assumed that the Global Navigation Satellite System (GNSS) is used to achieve the UE's position. The UE may utilize its position and the satellite's position and/or speed for synchronization in both of time domain and frequency domain. The position and speed of the satellite may be obtained from information broadcasted by the network. Thus, before the UE performs UL transmissions, the UE should firstly achieve the GNSS information, which will take about 1 second (e.g., hot start) or 5 seconds (e.g., warm start). The UE then reads satellite ephemeris data broadcasted by the network and indicating the satellite's position and speed, and do UL pre-compensation for a UE-specific timing advance (TA), denoted by N_{TA, UE-specific} and frequency adjustment.

In particular, for NR NTN, the TA applied by a UE, which is denoted by T_{TA}, may be given as below.

$${T}_{TA} = ( {N}_{TA} + {N}_{TA , UE - specific} + {N}_{TA , common} + {N}_{TA , offset} ) \times {T}_{s} \qquad ( 1 )$$

where N_{TA} is defined as 0 for PRACH (Physical random-access channel) and may be updated based on the TA command field in MSG2/MSGB and the MAC CE TA command; N_{TA, UE-specific} is the UE self-estimated TA to pre-compensate for the service link delay; N_{TA, common} is the network controlled common TA, and may include any timing offset considered necessary by the network; N_{TA, offset} is a fixed offset used for calculating T_{TA}. Tₛ represent a number of time units in seconds that defines a size of fields in time domain, and in particular, Tₛ may be determined to be:

$${T}_{s} = 1 / ( 15000 \times 2048 ) \qquad ( 2 )$$

In addition, UL/DL transmissions and sidelink transmissions may be organized into radio frames with a duration of T_{f}=307200×Tₛ=10 ms.

As mentioned above, N_{TA, UE-specific} is estimated based on GNSS information and the satellite ephemeris data provided in system broadcast information. However, to save power, the UE may not always read the GNSS information and the satellite ephemeris data. Instead, the satellite ephemeris data before read by the UE is considered as valid during a validity timer is running. When the validity timer almost expires, the UE has to read the ephemeris data again.

Additionally, for some cases, N_{TA, common} is also provided in system broadcast information, for example, system information block (SIB). When a repetition period configured for UL is R>1 or even very long, such as, several seconds or several tens of seconds, the UE is unable to adjust the UL transmission timing autonomously to align with new ephemeris data during an ongoing repetition period other than at an initial transmission. Thus, it is possible for the UE to interrupt transmitting the UL transmission repetitions to update the ephemeris data. After reading a new satellite ephemeris data, the UE needs to use the new satellite ephemeris data to generate a new and valid UL synchronization information, denoted by N_{TA, UE-specific, new}, and then calculate the TA based on NTA, UE-specific, new. This will lead to a TA jump as compared with the TA calculated based on the old satellite ephemeris data, i.e., the old N_{TA, UE-specific, old}. The updating of GNSS information has the similar issue.

However, the network device (e.g., eNB, gNB, etc.) does not know the exact difference between the UL synchronization information previously updated and the new UL synchronization information lately updated. This may cause an issue. Given the specific TA as an example for discussion, the network device does not know the exact TA difference between the one calculated based on N_{TA, UE-specific, old} and the one calculated based on N_{TA, UE-specific, new}. This is because the signals with different TAs will have different phases. As the UE is performing UL transmission repetitions, it cannot report the TA difference. As a result, the combination of repetitions using N_{TA, UE-specific, old} and the repetitions using N_{TA, UE-specific, new} with different phases will have a reduced combination gain at the network device side. By way of example, if a phase difference between them is 180°, the combination of the repetitions will be zero, that is, (1)+ (−1)=0, where 1 and −1 represent the signal repetitions with N_{TA, UE-specific, old} and N_{TA, UE-specific, new}, respectively.

It should be noted that, the updating of common TA would cause a similar issue as well, even that the common TA that describing the drift of the common TA for the feeder link is expected to have a more smooth progression in time domain. In addition, similar issue for the jump of frequency Doppler shift within the repetitions will have similar impacts on the combination of the repetitions.

In order to solve the above and other potential problems, embodiments of the present disclosure provide an enhanced UL transmission mechanism. In the mechanism, both of the UE and the network device are aware of the TA/phase jump due to updating the UL synchronization information during UL repetitions. In this way, the network device knows how to effectively combine or select the repetitions for a better performance, in a case that the UE automatically adjusts its TA during the repetitions.

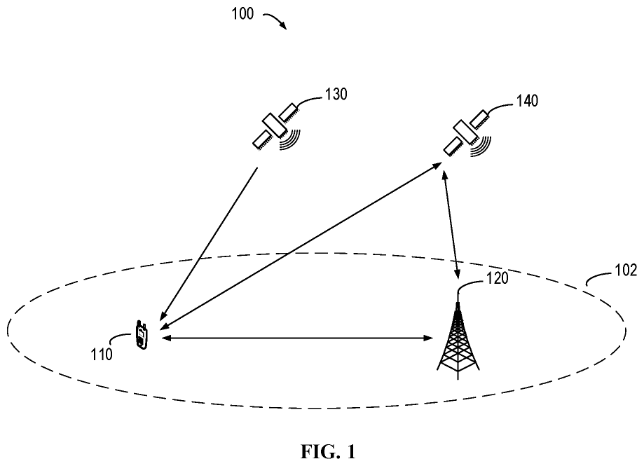

FIG. 1 illustrates an example network environment 100 in which embodiments of the present disclosure can be implemented. The network environment 100 may be an NTN system which includes a first device 110, a second device 120, a first NTN device 130 and a second NTN device 140.

As shown in FIG. 1, the first device 110 may be implemented as a terminal device, such as, a NB-IoT UE. The second device 120 may be implemented as a network device, such as, an eNB or gNB. In the context of the example embodiments, the first device 110 may be also referred to as the UE 110 or the terminal device 110, and the second device 120 may be also referred to as the network device 120.

The first NTN device 130 may provide positioning service to the earth stations including the first device 110 and the second device 120. The first NTN device 130 may include, but not limited to a satellite supporting the GNSS. The second NTN device 140 may provide coverage enhancement and relay functions, which may be the LEO satellite.

The second device 120 may be communicated with the second NTN device 140 via a feeder link and provide radio coverage in a cell 102 where the first device 110 and the second device 120 may communicate with each other via a UL or DL channel. In particular, the direction from the first device 110 to the second device 120 may refer to UL, and the direction from the second device 120 to the first device 110 may refer to DL.

In the NTN scenario, the network device may be deployed either on the ground or on a satellite. In the example shown in FIG. 1, the second device 120 is deployed on the ground and connected to the second NTN device 140, and thus the radio coverage may be discontinuous. As previously described, the LEO satellite has a speed relative to Earth, as about 7.56 km/second. Due to a change of distance between the first device 110 and the second device 120, the first device 110 needs to adjust UL synchronization information along with the movement of the second device 120, which will be discussed in details below.

The UL synchronization information may include, but not limited to, the timing advance in time domain and the frequency Doppler shift in frequency domain. In particular, the first device 110 may obtain satellite ephemeris data associated with the second device 120 by reading system broadcast information, such as, system information block (SIB) from the second device 120. Additionally or alternatively, the first device 110 may obtain its position information by reading system broadcast information from GNSS.

The first device 110 may then estimate N_{TA, UE-specific} based on the satellite ephemeris data and the position information. Similarly, the first device 110 may determine N_{TA, common} based on the SIB. For the purpose of power saving, the first device 110 may not need to read the system broadcast information during a validity timer for the satellite ephemeris is running. When the validity timer almost expires, the first device 110 may read the system broadcast information again, and then determine the new UL synchronization information. Since either the ephemeris data or the position of the first device 110 may change, the new UL synchronization information may have TA jump compared with the old UL synchronization information.

In order to guarantee the quality of packet transmission, the first device 110 may transmit UL transmission repetitions to the second device 120. Hence, there may be a case when the first device 110 is performing the UL transmission repetitions, and the validity timer almost expires, the first device 110 has to pause the transmission of the UL transmission repetitions to read the system broadcast information. In addition, the new UL synchronization information determined based on the system broadcast information may be used for transmitting the following UL transmission repetitions.

It should be understood that the number of the devices as shown in FIG. 1 is given only for illustrative purpose without suggesting any limitations. For example, the network environment 100 may include any suitable number of terminal devices and network devices adapted for implementing embodiments of the present disclosure. The present disclosure is not limited in this regard.

The communications in the network environment 100 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), a future sixth generation (6G) and/or any further communication protocols.

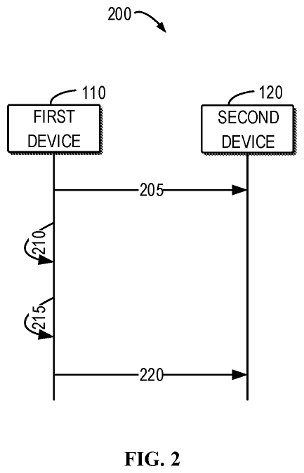

Principle and implementations of the present disclosure will be described in detail below with reference to FIG. 2. FIG. 2 shows a signaling chart illustrating an example UL transmission procedure according to some example embodiments of the present disclosure. For the purpose of discussion, the process 200 will be described with reference to FIG. 1. The process 200 may involve the first device 110 and the second device 120.

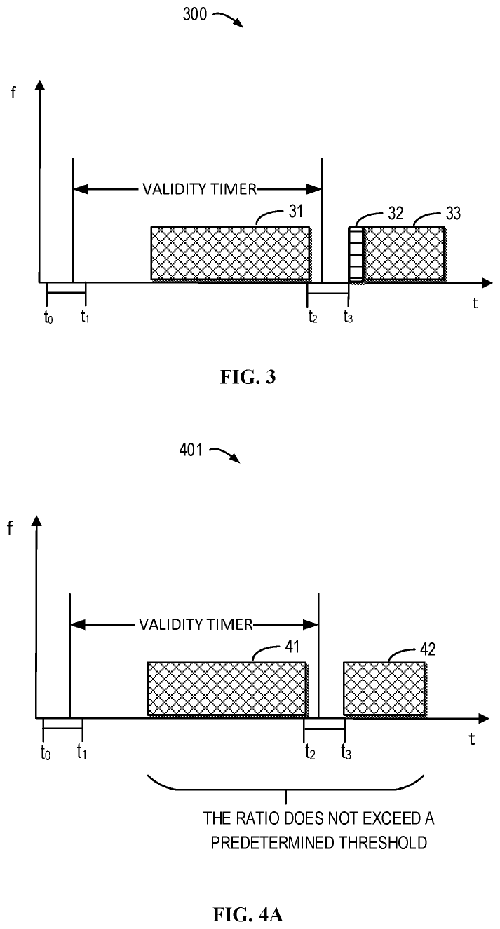

In the process 200, the first device 110 read system broadcast information for deriving transmission compensation in at least one of time domain and frequency domain. The system broadcast information may include, but not limited to, the satellite ephemeris data, the GNSS information, and so on. As shown in FIGS. 3 to 5, the first device 110 may read the system broadcast information during a time period from t₀ to t₁, and start a validity timer.

The first device 110 may determine first UL synchronization information based on the system broadcast information. The first UL synchronization information may be, such as, N_{TA, UE-specific, old}, N_{TA, common} and so on. The first device 110 transmits 205 a first group of transmission repetitions based on the first UL synchronization information. In addition, during the validity timer is running, the first device 110 would not read the system broadcast information.

As the validity timer is about to expire, the first device 110 pauses to transmit the UL transmission repetitions, and reads 210 the system broadcast information again during a time period from t₂ to t₃. The first device 110 then determines 215 second UL synchronization information based on the latest system broadcast information. Since the system broadcast information may change, the second UL synchronization information may be different from the first UL synchronization information. The second UL synchronization information may be used for transmitting the following UL transmission repetitions, i.e., a second group of transmission repetitions.

The first device 110 transmits 220 the second group of transmission repetitions based on the second UL synchronization information. From the perspective of the second device 120, it should know how to receive UL transmission repetitions with different synchronization information, i.e., the first UL synchronization information and the second UL synchronization information.

In some example embodiments, a UE assistance signal is introduced as an explicit indication for estimating the TA and/or phase difference between the first group of transmission repetitions and the second group of transmission repetitions. Now reference is made to FIG. 3, which illustrates an example of UL transmission repetitions with a UE assistance signal according to some example embodiments of the present disclosure.

As shown in FIG. 3, the first group of transmission repetitions 31 has been transmitted based on the first UL synchronization information. During the time period from t₂ to t₃, the first device 110 determines the second UL synchronization information by reading the system broadcast information. To inform the second device 120 of estimating the TA and/or phase difference, the UE assistance signal 32 is inserted into the second group of transmission repetitions 33. In this way, upon receiving the UE assistance signal, the second device 120 may be aware that the transmission repetitions transmitted after the UE assistance signal 32 should be associated with the second UL synchronization information.

In some example embodiments, the UE assistance signal 32 may be a group of demodulation reference signals (DMRSs) in the second group of transmission repetitions. The group of DMRSs in the second group of transmission repetitions has a different characteristic from a group of DMRSs in first group of transmission repetitions. The characteristic may include, but not limited to, transmission power, density, pattern, frequency associated with the DMRSs and so on.

By way of example, the DMRSs distributed in at least a part of the second group of transmission repetitions may be more densely than the DMRSs distributed in at least a part of the first group of transmission repetitions. For another example, the DMRSs or a RS sequence may be inserted in the second group of transmission repetitions. In these examples, the UE assistance signal may be predefined or configured with parameters, e.g. the density of the DMRS, the sequence, the length of the UE assistance signal in time domain, etc.

In some example embodiments, the UE assistance signal 32 may be transmitted in dedicated resources in the second group of transmission repetitions. The dedicated resource could be the same resource for the repetition or different resources for the repetitions.

Alternatively, in some other embodiments, an implicit indication may be used for indicating the estimation of the TA and/or phase difference. Taking the satellite ephemeris data as an example, the broadcast time of the satellite ephemeris data may not be aligned with the transmission gaps of the first device 110 scheduled with transmission repetitions. If the first device 110 determines that the validity timer is about to expire, it may pause the transmission of repetitions and receive the updated satellite ephemeris data. In this case, there may be a transmission gap between the first group of transmission repetitions and the second group of transmission repetitions. Upon detecting the transmission gap, the network may know that the new UL synchronization information will be applied when the first device 110 continues to transmit the UL transmission repetitions, and the first device 110 may provide the UE assistance signal in the corresponding resources.

In some example embodiments, the second device 120 may determine whether the transmission gap exceeds a threshold. If the transmission gap exceeds the threshold, the second device 120 may determine that the second UL synchronization information is to be used for the second group of transmission repetitions.

The first device 110 may determine whether to transmit the second group of transmission repetitions based on the first UL synchronization information or based on the second UL synchronization information by considering a condition for changing transmission compensation. For example, if the first device 110 determines that the condition for changing transmission compensation is met, the second group of transmission repetitions may be transmitted based on the second UL synchronization information. Otherwise, if the first device 110 determines that the condition for changing transmission compensation is not met, the second group of transmission repetitions may be transmitted based on the first UL synchronization information.

In some example embodiments, the condition for changing transmission compensation may be associated with a ratio of the number of the remaining repetitions to be transmitted to a total number of repetitions. To this end, the first device 110 may determine the ratio of the number of the second group of transmission repetitions to the total number of the transmission repetitions.

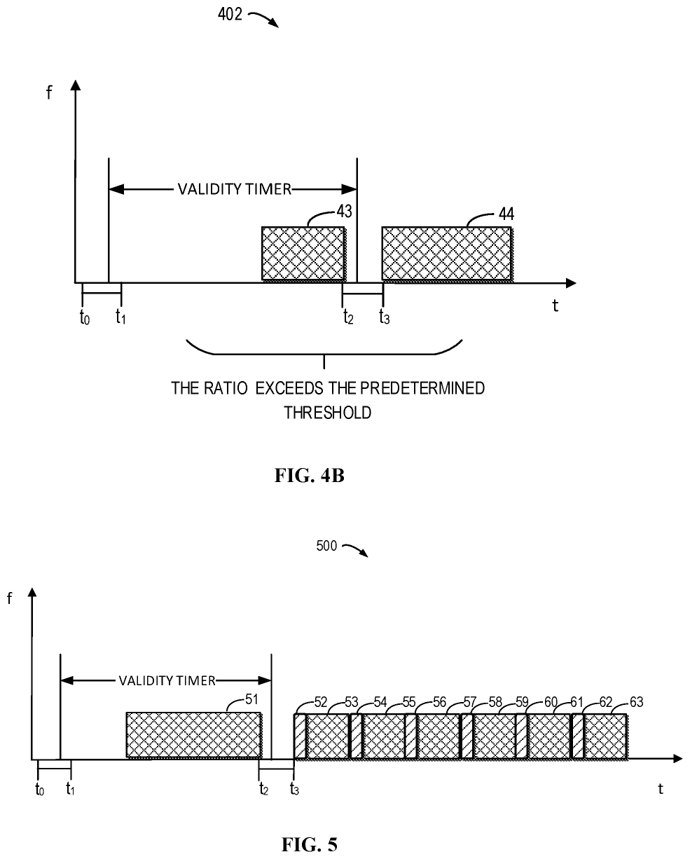

Now reference is made to FIGS. 4A-4B, which illustrate examples of UL transmission repetitions according to some example embodiments of the present disclosure. As shown in FIG. 4A, since the ratio of the second group of transmission repetitions 42 to the total transmission repetitions 41 and 42 does not exceed a threshold (e.g., a threshold of TA utilization), the first device 110 determines that the condition for changing the transmission compensation is not met. In this case, the first device 110 may transmit the second group of transmission repetitions based on the first UL synchronization information.

Otherwise, as shown in FIG. 4B, the ratio of the second group of transmission repetitions 44 to the total transmission repetitions 43 and 44 exceeds the threshold, the first device 110 determines that the condition for changing the transmission compensation is met. In this case, the first device 110 may transmit the second group of transmission repetitions based on the second UL synchronization information. The threshold may be predefined or configured based on an elevation angle of the first device 110, so that the best repetition transmission can be used in the network processing or combination.

As such, the network can select the best processing or combination from the transmission repetitions. By properly setting the ratio threshold, it can be guaranteed that a number of transmission repetitions larger than the threshold of TA utilization, e.g., 50%, will have the same TA or phase, and thus the combination of the transmission repetitions would have no issue for the combination gain. In this way, the main combination gain will be protected and achieved without pollution.

In some example embodiments, the condition for changing transmission compensation may be associated with the network configuration. Based on the network configuration, both of the first device 110 and the second device 120 will know whether the second UL synchronization information will be used during transmitting the repetitions. The network configuration may be contained in one of downlink control information (DCI), a MAC CE, a RRC IE and so on.

For example, the DCI may be used for indicating that for each of transmission repetitions, whether the first UL synchronization information or the second UL synchronization information is to be used.

For another example, the MAC CE or the RRC IE may be used for indicating whether the first UL synchronization information or the second UL synchronization information is to be used in all of the following transmission repetitions.

In this way, both the UE and the network device would know whether new UL synchronization information is to be used during transmitting the repetitions. In addition, the UE can use the TA correspondingly, and the network device is aware of whether there is TA changing during the repetitions. The network device may in turn combine the repetitions separately, and select the best repetition part or combination as the best receiving signal from the UE.

In some example embodiments, the new UL synchronization information may only be used at beginning of a target group of repetitions after determining the new UL synchronization information. The position of the target group of repetitions may be configured by the second device 120 or preconfigured at the first device 110 and the second device 120.

In some cases, the target group of repetitions is also referred to as a segment. For example, the target group of repetitions may be the Nth segment starting after reading the new UL synchronization information, where N could be an integer greater than or equal to 1 and the number of N may be predefined or configured by the network.

FIG. 5 shows a schematic diagram illustrating still another example of UL transmission repetitions according to some example embodiments of the present disclosure. As shown in FIG. 5, the first group of transmission repetitions is associated with the first UL synchronization information, and for the second group of transmission repetitions, only the target groups of repetitions, e.g., one of 52, 54, 56, 58, 60 and 62 at the beginning of each segments 53, 55, 57, 59, 61, 63 are associated with the second UL synchronization.

According to the example embodiments, there is provided an enhanced mechanism for UL transmission repetitions. Such a mechanism is especially beneficial to NTN scenarios. In the enhanced mechanism, both the UE and the network device are aware of the TA/phase jump due to updating UL synchronization information during transmitting UL repetitions. Therefore, the network device is capable of effectively combining or selecting repetitions for a better performance, especially in a case that the UE automatically adjusts its TA during the repetitions.

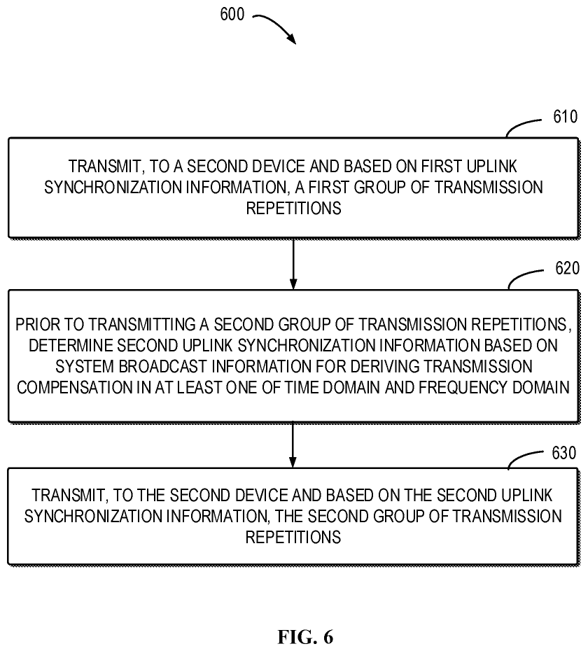

FIG. 6 illustrates a flowchart of an example method 600 implemented at a first device according to example embodiments of the present disclosure. The method 600 can be implemented by a terminal device, such as, the first device 110 shown in FIG. 1. Additionally or alternatively, the method 600 can be implemented by any other terminal device. For the purpose of discussion, the method 600 will be described with reference to FIG. 1. It is to be understood that method 600 may further include additional blocks not shown and/or omit some shown blocks, and the scope of the present disclosure is not limited in this regard.

At 610, the first device 110 transmits, to the second device 120 and based on first UL synchronization information, a first group of transmission repetitions.

At 620, prior to transmitting a second group of transmission repetitions, the first device 110 determines second UL synchronization information based on system broadcast information for deriving transmission compensation in at least one of time domain and frequency domain.

In some example embodiments, the system broadcast information may be used for synchronizing the first device 110 and second device 120 in at least one of time domain and frequency domain. The system broadcast information may comprise at least one of GNSS information of the first device 110 and ephemeris data associated with the second device 120.

In some example embodiments, the first device 110 may transmit an indication that the second UL synchronization information is to be used along with the second group of transmission repetitions. The indication may be in form of a UE assistance signal. In this way, the network device is informed of measuring the TA and/or frequency compensation adjustment. In addition, the network device is aware that the repetitions of UL transmission after the indication would be associated with the new UL synchronization information.

The indication may be contained in a group of DMRSs in the second group of transmission repetitions, and the group of DMRSs has a different characteristic from a group of DMRSs in first group of transmission repetitions. The characteristic may include, but not limited to, transmission power, density, pattern, frequency associated with the DMRS and so on. For example, the DMRSs distributed in at least a part of the repetitions that are transmitted after the updating of UL synchronization information may be more densely than DMRSs distributed in at least a part of repetitions that are transmitted before the updating of UL synchronization information. For another example, the DMRSs or a RS sequence may be inserted in the repetitions that are transmitted after the updating of UL synchronization information.

Alternatively, the indication may be contained in dedicated resources in the second group of transmission repetitions. The dedicated resource could be the same resource for the repetition or different resources for the repetitions.

At 630, the first device 110 transmits, to the second device 120 and based on the second UL synchronization information, the second group of transmission repetitions. The second UL synchronization information may comprise at least one of specific timing advance information estimated by the first device 110, common timing advance information controlled by the second device 120, and frequency Doppler shift information.

In some example embodiments, the first device 110 may determine whether a condition for changing transmission compensation is met or not. If the condition for changing the transmission compensation is met, the first device 110 may transmit the second group of transmission repetitions based on the second UL synchronization information. Otherwise, if the condition for changing the transmission compensation is not met, the first device 110 may transmit the second group of transmission repetitions based on the first UL synchronization information.

In some example embodiments, the second UL synchronization information indicates changed transmission compensation with respect to the first UL synchronization information.

In some example embodiments, a transmission gap for determining the second UL synchronization information is between the first group of transmission repetitions and the second group of transmission repetitions. The transmission gap exceeding a threshold may indicate the second UL synchronization information to be used for the second group of transmission repetitions. The threshold of the transmission gap may be either configured by the second device 120, or preconfigured at the first device 110 and the second device 120. Thus, from the perspective of the network, if the network device detects a transmission gap that exceeds the threshold, it may determine that the repetitions transmitted after the gap is associated with the new UL synchronization information. Otherwise, if the network device detects a transmission gap that does not exceed the threshold, it may determine that the repetitions transmitted after the gap is associated with the old UL synchronization information.

In some example embodiments, the condition for changing the transmission compensation may be associated with a ratio of the number of the remaining repetitions to be transmitted to a total number of repetitions. For example, a plurality of transmission repetitions to be transmitted to the second device 120 may comprise the first group of transmission repetitions and the second group of transmission repetitions. The first device 110 may determine the ratio of the second group of transmission repetitions to the plurality of the transmission repetitions. If the ratio exceeds a threshold, the first device 110 may determine that the condition for changing the transmission compensation is met. Otherwise, if the ratio does not exceed the threshold, the first device 110 may determine that the condition for changing the transmission compensation is not met. The threshold may be either configured by the second device 120, or alternatively, preconfigured at the first device 110 and the second device 120.

In the above embodiments, the second device 120 may similarly determine the ratio and make similar determination. For example, if the ratio of the number of repetitions transmitted after a transmission gap (e.g., the number of the second group of transmission repetitions) to the total number of repetitions (e.g., the number of the plurality of transmission repetitions) exceeds the threshold, the second device 120 may determine that the repetitions transmitted after the transmission gap are associated with the new UL synchronization information. Otherwise, if the ratio does not the threshold, the second device 120 may determine that the repetitions transmitted after the transmission gap are associated with the old UL synchronization information.

In some example embodiments, the transmission compensation may comprise at least one of a timing advance in time domain and a frequency compensation in frequency domain, and the condition for changing the transmission compensation indicates that the timing advance and/or the frequency compensation determined based on system broadcast information has changed more than a corresponding threshold. The threshold may be either configured by the second device 120, or preconfigured at the first device 110 and the second device 120.

The condition for changing the transmission compensation may be indicated via the network configuration. In some example embodiments, the first device 110 may receive a configuration message from the second device 120 for indicating at least one of (i) the second UL synchronization information to be used for transmitting the second group of transmission repetitions, and (2) a time for applying the second UL synchronization information. In this way, the utilization of the new UL synchronization information is controlled by the network, and both the network device and the UE know whether the new UL synchronization information should be used in the UL transmission repetitions.

The configuration message may be the DCI, the RRC message or the MAC CE. By way of example, the DCI may indicate that the second UL synchronization information is to be used for each of the second group of transmission repetitions. By way of another example, the RRC message or the MAC CE may indicate that the second UL synchronization information is to be used in all of the second group of transmission repetitions.

In the above embodiments, the second UL synchronization information may be used at the beginning of a target group of repetitions after determining the second UL synchronization information. The position of the target group of repetitions may be either configured by the second device 120 or preconfigured at the first device 110 and the second device 120.

In some cases, the target group of repetitions is also referred to as a segment. For example, the target group of repetitions may be the Nth segment starting after reading the new UL synchronization information, where N could be an integer greater than or equal to 1 and the number of N may be predefined or configured by the network.

In some example embodiments, the first device 110 may be a terminal device, such as, a UE. The second device 120 may be a network device, such as, a network device deployed either on the ground or on the satellite.

According to the example embodiments, there is provided a method for UL transmission. The method helps guarantee the effective receipt of UL repetitions with timing advance jump or update due to changing of UL synchronization information. In addition, the network knows how to combine or select repetitions for a better performance when the UE automatically adjusts the timing advance during the repetitions.

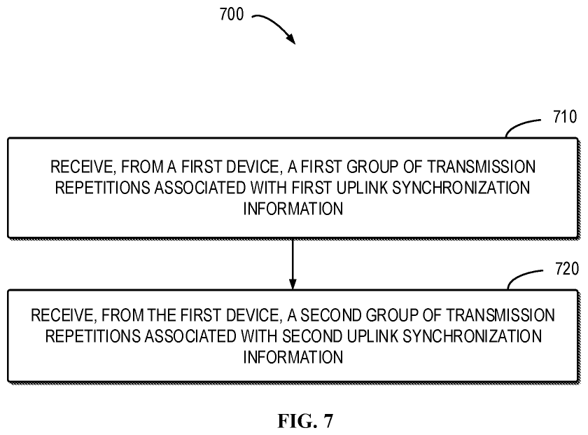

FIG. 7 illustrates a flowchart of an example method 700 implemented at a second device according to example embodiments of the present disclosure. The method 700 can be implemented by a network device, such as, the second device 120 shown in FIG. 1. Additionally or alternatively, the method 700 can be implemented by any other network device or entity. For the purpose of discussion, the method 700 will be described with reference to FIG. 1. It is to be understood that method 700 may further include additional blocks not shown and/or omit some shown blocks, and the scope of the present disclosure is not limited in this regard.

At 710, the second device 120 receives, from the first device 110, a first group of transmission repetitions associated with first UL synchronization information.

In some example embodiments, the second device 120 may transmit, to the first device 110, system broadcast information for deriving transmission compensation in at least one of time domain and frequency domain. The system broadcast information may include ephemeris data associated with the second device 120.

At 720, the second device 120 receives, from the first device 110, a second group of transmission repetitions associated with second UL synchronization information.

The second UL synchronization information may be different from the first UL synchronization information. In particular, the first UL synchronization information may be considered as the old UL synchronization information, while the second UL synchronization information may be considered as the new UL synchronization information.

The second UL synchronization information may comprise at least one of specific timing advance information estimated by the first device, common timing advance information controlled by the second device, frequency Doppler shift information.

In some example embodiments, the second device 120 may determine whether a condition for changing transmission compensation is met or not. If the condition is met, the second device 120 may determine that the second group of transmission repetitions is to be received based on the second UL synchronization information.

In some example embodiments, the second UL synchronization information is associated with changed transmission compensation with respect to the first UL synchronization information.

The second device 120 may determine whether the second group of transmission repetitions is associated with the first UL synchronization information or with the second UL synchronization information based on a transmission gap that is used by the first device 110 for determining the second UL synchronization information.

In some example embodiments, if the transmission gap between the first group of transmission repetitions and the second group of transmission repetitions exceeds a threshold, the second device 120 may determine that the condition for changing the transmission compensation is met.

In some example embodiments, the condition for changing the transmission compensation may be associated with a ratio of the number of the remaining repetitions to be transmitted to a total number of repetitions. For example, a plurality of transmission repetitions received from the first device 110 may comprise the first group of transmission repetitions and the second group of transmission repetitions. The second device 120 may determine the ratio of the second group of transmission repetitions to the plurality of the transmission repetitions. If the ratio exceeds a threshold, the second device 120 may determine that the condition for changing the transmission compensation is met, and in this case, the second group of repetitions is associated with the second UL synchronization information. Otherwise, if the ratio does not exceed the threshold, the second device 120 may determine that the condition for changing the transmission compensation is not met. The threshold may be configured by the second device 120, or alternatively, preconfigured at the first device 110 and the second device 120.

In some example embodiments, the second device 120 may receive, from the first device 110, an indication that the second UL synchronization information is to be used along with the second group of transmission repetitions. The indication may be in form of a UE assistance signal. In this way, the network device is informed of measuring the TA and/or frequency compensation adjustment. In addition, the network device is aware that the repetitions of UL transmission after the indication would be associated with the new UL synchronization information.

In some example embodiments, the indication may be contained in a group of DMRSs in the second group of transmission repetitions, and the group of DMRSs has a different characteristic from a group of DMRSs in first group of transmission repetitions. The characteristic may include, but not limited to, transmission power, density, pattern, frequency associated with the DMRS and so on. For example, the DMRSs distributed in at least a part of the repetitions that are transmitted after the updating of UL synchronization information may be more densely than DMRSs distributed in at least a part of repetitions that are transmitted before the updating of UL synchronization information. For another example, the DMRSs or a RS sequence may be inserted in the repetitions that are transmitted after the updating of UL synchronization information.

Alternatively, the indication may be contained in dedicated resources in the second group of transmission repetitions.

In some example embodiments, the second device 120 may transmit, to the first device 110, a configuration message for indicating at least one of (i) the second UL synchronization information to be used for transmitting the second group of transmission repetitions, and (2) a time for applying the second UL synchronization information. In this way, the utilization of the new UL synchronization information is controlled by the network, and both the network device and the UE know whether the new UL synchronization information should be used in the UL transmission repetitions.

The configuration message may be the DCI, the RRC message or the MAC CE. By way of example, the DCI may indicate that the second UL synchronization information is to be used for each of the second group of transmission repetitions. By way of another example, the RRC message or the MAC CE may indicate that the second UL synchronization information is to be used in all of the second group of transmission repetitions

In the above embodiments, the second device 120 may apply the second UL synchronization information at the beginning of a target group of repetitions in the second group of transmission repetitions. The position of the target group of repetitions may be configured by the second device 120 or preconfigured at the first device 110 and the second device 120.

In some cases, the target group of repetitions is also referred to as a segment. For example, the target group of repetitions may be the Nth segment starting after reading the new UL synchronization information, where N could be an integer greater than or equal to 1 and the number of N may be predefined or configured by the network.

In some example embodiments, the first device 110 may be a terminal device, such as, a UE. The second device 120 may be a network device, such as, a network device deployed either on the ground or on the satellite.

In some example embodiments, a first apparatus capable of performing any of the method 600 (for example, the first device 110) may comprise means for performing the respective steps of the method 600. The means may be implemented in any suitable form. For example, the means may be implemented in a circuitry or software module.

In some example embodiments, the first apparatus comprises: means for transmitting, to a second apparatus, a first group of transmission repetitions based on first UL synchronization information; means for prior to transmitting a second group of transmission repetitions, determining second UL synchronization information based on system broadcast information for deriving transmission compensation in at least one of time domain and frequency domain; and means for transmitting, to the second apparatus and based on the second UL synchronization information, the second group of transmission repetitions.

In some example embodiments, the means for transmitting the second group of transmission repetitions comprises: means for determining whether a condition for changing transmission compensation is met or not; means for in accordance with a determination that the condition for changing transmission compensation is met, transmitting the second group of transmission repetitions based on the second UL synchronization information; or means for in accordance with a determination that the condition for changing transmission compensation is not met, transmitting the second group of transmission repetitions based on the first UL synchronization information.

In some example embodiments, the second UL synchronization information is associated with a changed transmission compensation with respect to the first UL synchronization information.

In some example embodiments, a plurality of transmission repetitions to be transmitted to the second apparatus comprises the first group of transmission repetitions and the second group of transmission repetitions. The means for determining whether the condition for changing the transmission compensation is met comprises: means for determining a ratio of the second group of transmission repetitions to the plurality of the transmission repetitions; means for in accordance with a determination that the ratio exceeds a threshold, determining that the condition for changing the transmission compensation is met; and means for in accordance with a determination that the ratio is not exceeding the threshold, determining that the condition for changing the transmission compensation is not met.

In some example embodiments, the transmission compensation comprises at least one of a timing advance in time domain and a frequency compensation in frequency domain, and the condition for changing the transmission compensation indicates that the timing advance and/or the frequency compensation determined based on system broadcast information has changed more than a corresponding threshold. The threshold is configured by the second apparatus, or preconfigured at the first apparatus and the second apparatus.

In some example embodiments, the first apparatus further comprises: means for transmitting an indication that the second UL synchronization information is to be used along with the second group of transmission repetitions.

In some example embodiments, the indication is contained in a group of demodulation reference signals, DMRSs, in the second group of transmission repetitions, and the group of DMRSs has a different characteristic from a group of DMRSs in the first group of transmission repetitions.

In some example embodiments, a transmission gap for determining the second UL synchronization information is between the first group of transmission repetitions and the second group of transmission repetitions, and the transmission gap exceeding a threshold indicates the second UL synchronization information to be used for the second group of transmission repetitions.

In some example embodiments, the first apparatus further comprises: means for receiving, from the second apparatus, a configuration message for indicating at least one of the following: the second UL synchronization information to be used for transmitting the second group of transmission repetitions, and a time for applying the second UL synchronization information.

In some example embodiments, the configuration message comprises one of downlink control information, DCI, and a RRC message or a MAC control element, CE.

In some example embodiments, the second UL synchronization information is to be used at the beginning of a target group of repetitions after determining the second UL synchronization information.

In some example embodiments, a position of the target group of repetitions is configured by the second apparatus or preconfigured at the first apparatus and the second apparatus.

In some example embodiments, the system broadcast information is used for synchronizing the first apparatus and second apparatus in at least one of time domain and frequency domain, and the system broadcast information comprises at least one of Global Navigation Satellite System, GNSS, information of the first apparatus and ephemeris data associated with the second apparatus.

In some example embodiments, the second UL synchronization information comprises at least one of specific timing advance information estimated by the first apparatus, common timing advance information controlled by the second apparatus, and frequency Doppler shift information.

In some example embodiments, the first apparatus comprises a terminal device, and a second apparatus comprises a network device.

In some example embodiments, a second apparatus capable of performing any of the method 700 (for example, the second device 120) may comprise means for performing the respective steps of the method 700. The means may be implemented in any suitable form. For example, the means may be implemented in a circuitry or software module.

In some example embodiments, the second apparatus comprises: means for receiving, from a first apparatus, a first group of transmission repetitions associated with first UL synchronization information; and means for receiving, from the first apparatus, a second group of transmission repetitions associated with second UL synchronization information.

In some example embodiments, the second apparatus further comprises: means for determining whether a condition for changing transmission compensation is met; and means for in accordance with a determination that the condition for changing transmission compensation is met, determining that the second group of transmission repetitions is to be received based on the second UL synchronization information.

In some example embodiments, the second UL synchronization information is associated with changed transmission compensation with respect to the first UL synchronization information.

In some example embodiments, the means for determining whether the condition for changing the transmission compensation is met comprises: means for in accordance with a determination that a transmission gap between the first group of transmission repetitions and the second group of transmission repetitions exceeds a threshold, determining that the condition for changing the transmission compensation is met.

In some example embodiments, a plurality of transmission repetitions received from the first apparatus comprises the first group of transmission repetitions and the second group of transmission repetitions. The means for determining whether the condition for changing the transmission compensation is met comprises: means for determining a ratio of the second group of transmission repetitions to the plurality of the transmission repetitions; and means for in accordance with a determination that the ratio exceeds a threshold, determining that the condition for changing the transmission compensation is met. The threshold may be configured by the second apparatus or preconfigured at the first apparatus and the second apparatus.

In some example embodiments, the second apparatus further comprises: means for receive, from the first apparatus, an indication that the second UL synchronization information is to be used along with the second group of transmission repetitions.

In some example embodiments, the indication is contained in a group of demodulation reference signals, DMRSs, in the second group of transmission repetitions, and the group of DMRSs has a different characteristic from a group of DMRSs in first group of transmission repetitions.

In some example embodiments, the second apparatus further comprises: means for transmitting, to the first apparatus, a configuration message for indicating at least one of the following: the second UL synchronization information to be used for transmitting the second group of transmission repetitions, and a time for applying the second UL synchronization information.

In some example embodiments, the configuration message comprises one of downlink control information, DCI, and a RRC message or a MAC control element, CE.

In some example embodiments, the second apparatus further comprises: means for applying the second UL synchronization information at the beginning of a target group of repetitions in the second group of transmission repetitions.

In some example embodiments, a position of the target group of repetitions is configured by the second apparatus or preconfigured at the first apparatus and the second apparatus.

In some example embodiments, the second apparatus further comprises: means for transmitting, to the first apparatus, system broadcast information for deriving transmission compensation in at least one of time domain and frequency domain, the system broadcast information comprising ephemeris data associated with the second apparatus.

In some example embodiments, the second UL synchronization information comprises at least one of specific timing advance information estimated by the first apparatus, common timing advance information controlled by the second apparatus, and frequency Doppler shift information.

In some example embodiments, the first apparatus comprises a terminal device, and a second apparatus comprises a network device.

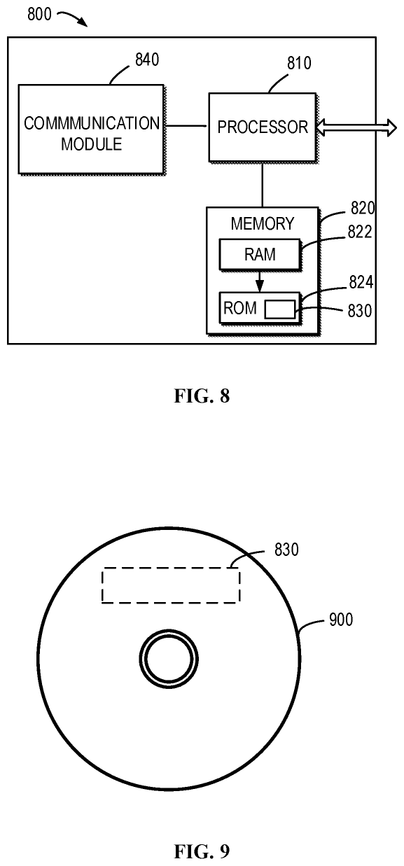

FIG. 8 is a simplified block diagram of a device 800 that is suitable for implementing embodiments of the present disclosure. The device 800 may be provided to implement the communication device, for example the first device 110 and the second device 120 as shown in FIG. 2. As shown, the device 800 includes one or more processors 810, one or more memories 820 coupled to the processor 810, and one or more transmitters and/or receivers (TX/RX) 840 coupled to the processor 810.

The TX/RX 840 may be configured for bidirectional communications. The TX/RX 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage media. Examples of the volatile memories include, but are not limited to, a random access memory (RAM) 822 and other volatile memories that will not last in the power-down duration.

A computer program 830 includes computer executable instructions that may be executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIG. 3. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 as described above with reference to FIGS. 6-7. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program codes;
the at least one memory and the computer program codes are configured to, with the at least one processor, cause the first device at least to:
transmit, to a second device and based on first uplink synchronization information, a first group of transmission repetitions;
prior to transmitting a second group of transmission repetitions, determine second uplink synchronization information based on system broadcast information for deriving transmission compensation in at least one of time domain and frequency domain; and
transmit, to the second device and based on the second uplink synchronization information, the second group of transmission repetitions.

2. The first device of claim 1, wherein the at least one memory and the computer program codes are configured to, with the at least one processor, cause the first device to transmit the second group of transmission repetitions by:
determining whether a condition for changing transmission compensation is met or not;
in accordance with a determination that the condition for the transmission compensation is met, transmitting the second group of transmission repetitions based on the second uplink synchronization information: or
in accordance with a determination that the condition for changing the transmission compensation is not met, transmitting the second group of transmission repetitions based on the first uplink synchronization information.

3. The first device of claim 2, wherein the second uplink synchronization information is associated with a changed transmission compensation with respect to the first uplink synchronization information.

4. The first device of claim 2, wherein a plurality of transmission repetitions to be transmitted to the second device comprises the first group of transmission repetitions and the second group of transmission repetitions, and
wherein the at least one memory and the computer program codes are configured to, with the at least one processor, cause the first device to determine whether the condition for changing the transmission compensation is met by:
determining a ratio of the second group of transmission repetitions to the plurality of the transmission repetitions;
in accordance with a determination that the ratio exceeds a threshold, determining that the condition for changing the transmission compensation is met; and
in accordance with a determination that the ratio is not exceeding the threshold, determining that the condition for changing the transmission compensation is not met.

5. The first device of claim 2, wherein the condition for changing the transmission compensation indicates that a timing advance and/or a frequency compensation determined based on the system broadcast information has changed more than a corresponding threshold and wherein the threshold is configured by the second device, or preconfigured at the first device and the second device.

6. (canceled)

7. The first device of claim 1, wherein the transmission compensation comprises at least one of a timing advance in time domain and a frequency compensation in frequency domain.

8. The first device of claim 1, wherein the at least one memory and the computer program codes are configured to, with the at least one processor, further cause the first device to:
transmit an indication that the second uplink synchronization information is to be used along with the second group of transmission repetitions wherein the indication is contained in a group of demodulation reference signals, DMRSs, in the second group of transmission repetitions, and the group of DMRSs has a different characteristic from a group of DMRSs in the first group of transmission repetitions.

9. (canceled)

10. The first device of claim 1, wherein a transmission gap for determining the second uplink synchronization information is between the first group of transmission repetitions and the second group of transmission repetitions, and the transmission gap exceeding a threshold indicates the second uplink synchronization information to be used for the second group of transmission repetitions.

11. The first device of claim 1, wherein the at least one memory and the computer program codes are configured to, with the at least one processor, further cause the first device to:
receive, from the second device, a configuration message for indicating at least one of the following:
the second uplink synchronization information to be used for transmitting the second group of transmission repetitions, and
a time for applying the second uplink synchronization information.

12-17. (canceled)

18. A second device, comprising:
at least one processor; and
at least one memory including computer program codes;
the at least one memory and the computer program codes are configured to, with the at least one processor, cause the second device at least to:
receive, from a first device, a first group of transmission repetitions associated with first uplink synchronization information; and
receive, from the first device, a second group of transmission repetitions associated with second uplink synchronization information.

19. The second device of claim 18, wherein the at least one memory and the computer program codes are configured to, with the at least one processor, further cause the second device to:
determine whether a condition for changing transmission compensation is met; and
in accordance with a determination that the condition for changing the transmission compensation is met, determine that the second group of transmission repetitions is to be received based on the second uplink synchronization information.

20. The second device of claim 19, wherein the at least one memory and the computer program codes are configured to, with the at least one processor, cause the second device to determine whether the condition for changing the transmission compensation is met by:
in accordance with a determination that a transmission gap between the first group of transmission repetitions and the second group of transmission repetitions exceeds a threshold, determining that the condition for changing the transmission compensation is met.

21. The second device of claim 19, wherein a plurality of transmission repetitions received from the first device comprises the first group of transmission repetitions and the second group of transmission repetitions, and
wherein the at least one memory and the computer program codes are configured to, with the at least one processor, cause the first device to determine whether the condition for changing the transmission compensation is met by:
determining a ratio of the second group of transmission repetitions to the plurality of the transmission repetitions;
in accordance with a determination that the ratio exceeds a threshold, determining that the condition for changing the transmission compensation is met.

22. The second device of claim 21, wherein the threshold is configured by the second device or preconfigured at the first device and the second device.

23. The second device of claim 18, wherein the second uplink synchronization information is associated with a changed transmission compensation with respect to the first uplink synchronization information.

24. The second device of claim 18, wherein the at least one memory and the computer program codes are configured to, with the at least one processor, further cause the second device to:
receive, from the first device, an indication that the second uplink synchronization information is to be used along with the second group of transmission repetitions, wherein the indication is contained in a group of demodulation reference signals, DMRSs, in the second group of transmission repetitions, and the group of DMRSs has a different characteristic from a group of DMRSs in first group of transmission repetitions.

25. (canceled)

26. The second device of claim 18, wherein the at least one memory and the computer program codes are configured to, with the at least one processor, further cause the second device to:
transmit, to the first device, a configuration message for indicating at least one of the following:
the second uplink synchronization information to be used for transmitting the second group of transmission repetitions, and
a time for applying the second uplink synchronization information.

27. (canceled)

28. The second device of claim 18, wherein the at least one memory and the computer program codes are configured to, with the at least one processor, further cause the second device to:
apply the second uplink synchronization information at the beginning of a target group of repetitions in the second group of transmission repetitions, wherein a position of the target group of repetitions is configured by the second device or preconfigured at the first device and the second device.

29-32. (canceled)

33. A method comprising:
transmitting, at a first device and to a second device, a first group of transmission repetitions based on first uplink synchronization information;
prior to transmitting a second group of transmission repetitions, determining second uplink synchronization information based on system broadcast information for deriving transmission compensation in at least one of time domain and frequency domain; and
transmitting, to the second device and based on the second uplink synchronization information, the second group of transmission repetitions.

34-37. (canceled)
